(19) United States
(12) Patent Application Publication
(10) Pub. No.: US 2012/0087456 A1
(43) Pub. Date: Apr. 12, 2012

(54) APPARATUS AND METHOD FOR REINFORCING PIPING ARRANGEMENT OF REACTOR CORE SPRAY SYSTEM

(75) Inventors: Naotaka Suganuma, Yokohama-Shi (JP); Masakazu Abura, Kawasaki-Shi (JP); Kazuo Sudo, Yokohama-Shi (JP); Satoshi Sato, Yokohama-Shi (JP); Haruhiko Hata, Yokohama-Shi (JP); Yukiaki Hidaka, Isehara-Shi (JP); Keiji Matsunaga, Yokohama-Shi (JP); Kanemi Hirose, Yokosuka-Shi (JP)

(73) Assignee: KABUSHIKI KAISHA TOSHIBA, Tokyo (JP)

(21) Appl. No.: 13/328,812

(22) Filed: Dec. 16, 2011

Related U.S. Application Data
(63) Continuation of application No. 12/989,341, filed on Jan. 14, 2011, now abandoned.

(30) Foreign Application Priority Data
Apr. 23, 2008 (JP) 2008-113116

(51) Int. Cl. G21C 9/00

(52) U.S. Cl. 376/282

(57) ABSTRACT

A reinforcing device includes a clamp that is disposed on an outer side of a welded portion of a core spray system piping and holds the core spray system piping at axially symmetrical points on an outer surface thereof, the piping being located on opposite sides of a weld line of the welded portion and also includes a bolt that is provided on the clamp so as to serve as a mechanical fastening mechanism applying a compressive force to the welded portion from the outside of the core spray system piping.

### TECHNICAL FIELD

The present invention relates to apparatus and method for reinforcing a piping arrangement of a reactor core spray system of a boiling water reactor (BWR).

### BACKGROUND ART

A piping arrangement of a reactor core spray system is one of core internals of a reactor pressure vessel (which may be called as core spray system piping). The core spray system piping introduces water from a suppression pool to a reactor spray sparger via external piping in order to prevent a fuel from being heated and a fuel cladding tube from being melt when the reactor core is exposed in a loss-of-coolant accident caused by a breakage in a recirculation system piping in a reactor.

FIG. 6 is a schematic perspective view showing a core spray system piping and the surroundings in a reactor pressure vessel. As shown in FIG. 6, in a reactor pressure vessel 1, two systems of core spray system pipings 3, each covering almost 180 degrees, are symmetrically arranged to form an annular structure that surrounds a reactor core.

The core spray system piping 3 is connected to a thermal sleeve welded to a safe end of a core spray nozzle of the reactor pressure vessel 1, and horizontally branches at a junction box 2 and is bent at an angle of about 90 degrees at an elbow portion 4 to form a half-annular structure along the inner wall of the reactor pressure vessel.

The half-annular structure is vertically bent at an end to form a vertical pipe portion (a rising pipe 5). The rising pipe 5 is connected to an inlet pipe 6 attached to an upper portion of a core shroud 8 via a core spray sparger pipe 7.

Core internals of the reactor pressure vessel 1 are formed by welding components made of stainless steel. It is known that, in a high-temperature aqueous environment, stainless steel having high carbon content suffers stress corrosion cracking that occurs in an area near the welded portion affected by the welding heat. There is an apprehension that stress corrosion cracking may occur also in the core spray system piping 3 that is used in contact with the reactor coolant at high temperature.

For the core spray system piping 3, stress corrosion cracking is particularly likely to occur in the welded portions, including a welded seam 9 between the junction box 2 and the core spray system piping 3, a welded seam 10 at an elbow portion, and a welded seam 10a between the rising pipe 5 and the inlet pipe 6.

If the welded seam 9, 10 or 10a of the core spray system piping 3 cracks in the circumferential direction, the core spray system may be unable to feed the coolant in a loss-of-coolant accident.

In order for the core spray system to maintain the welded seam 9, 10 and 10a and feed a required volume rate of flow even if the core spray system piping is broken at the weld line, it is desirable to provide a clamp device that provides a structural integrity of the welded seams 9, 10 and 10a.

According to a conventional method, an upper clamp and a lower clamp fasten the core spray system piping 3, and a crank disposed at the junction box 2 couples the clamps on the piping to each other (see Patent Document 1: Japanese Patent Laid-Open No. 2000-56060, for example).

According to the conventional method described above, the core spray system piping is fixed to the junction box. Therefore, the conventional method is not be applicable to a welded seam such as a weld line in an elbow portion and a weld line in a rising pipe.

### DISCLOSURE OF THE INVENTION

The present invention has been devised in view of such circumstances, and an object of the present invention is to provide a reinforcing device and a reinforcing method for core spray system piping that can prevent occurrence of a crack at any welded line in the core spray system piping, prevent widening of any crack occurring in the core spray system piping, and protect any welded seam at which a crack widens and the core spray system piping is broken to maintain the functionality of the core spray system in a loss-of-coolant accident.

To attain the object described above, a reinforcing device for core spray system piping provided by the present invention is a reinforcing device for core spray system piping that reinforces a welded part of core spray system piping of a boiling water reactor, comprising: a clamp that is disposed on an outer side of the welded part of the core spray system piping and holds the core spray system piping at axially symmetrical points on an outer surface of the core spray system piping located on opposite sides of a weld line of the welded part; and a mechanical fastening mechanism that is provided on the clamp and applies a compressive force to the welded part from outside of the core spray system piping.

Preferred embodiments of the present invention are as follows.

The clamp and the mechanical fastening mechanism may have a guide mechanism that restrains a twisting force and a bending force on the outer surface of the core spray system piping.

The clamp preferably has a fastening surface that has the same curvature as a curvature of the outer surface of the core spray system piping.

The clamp may comprise a plurality of components that hold the outer surface of the core spray system piping from opposite directions, and the components may be supported by a guide pin and a guide groove to which the guide pin is inserted, which are disposed to face each other.

Guide pins and guide grooves may be provided with magnets of opposite polarities in an alternate manner.

A protrusion may be formed on the clamp, and the protrusion may be engaged with a hole formed in the piping to restrict movement of the clamp.

A protrusion may be formed on the clamp, and the protrusion may be engaged with a groove formed in the piping to restrict movement of the clamp.

The clamp may be configured to allow approximately half or more of the length of the weld line of the welded part to be visually checked from above a reactor pressure vessel.

A portion of the core spray system piping to be reinforced may be an elbow pipe.

According to another aspect of the present invention, there is provided a reinforcing method for core spray system piping using a reinforcing device for core spray system piping for reinforcing a welded part of a core spray system piping of a boiling water reactor comprising a clamp that holds the core spray system piping at axially symmetrical points on an outer surface of the core spray system piping and a mechanical fastening mechanism that is provided on the clamp and applies a compressive force, wherein the clamp holds the core spray system piping at axially symmetrical points on the outer surface of the core spray system piping, and the mechanical fastening mechanism applies a compressive force to the welded part from outside of the core spray system piping to prevent occurrence of a crack at a weld line in the core spray system piping, prevent widening of a crack in the core spray system piping, and maintain a functionality of the core spray system piping in a case where the core spray system piping is broken at the weld line.

According to the present invention, a crack can be prevented from occurring at any welded line in the core spray system piping, any crack occurring in the core spray system piping can be prevented from widening, any welded seam can be protected even if a crack occurs at the welded seam and widens, and the core spray system piping is broken at the welded seam, and thus the functionality of the core spray system can be maintained in a loss-of-coolant accident.

The reinforcing device according to the present invention can be attached to core spray system piping in water in the reactor from above the reactor pressure vessel by remote control and without any special tool and can hold the core spray system piping for a period of time equivalent to the design life of the plant.

### BRIEF DESCRIPTION OF THE DRAWINGS

FIG. 1 is a perspective view of a reinforcing device according to an embodiment of the present invention.

FIG. 2 is an exploded perspective view showing an arrangement of components of the reinforcing device according to the embodiment of the present invention.

FIG. 3 is a cross-sectional view taken along the line III-III in FIG. 1.

FIG. 4 is a perspective view showing a configuration of the reinforcing device.

FIG. 5 is a perspective view showing another embodiment of the present invention.

FIG. 6 is a perspective view showing an arrangement of core spray piping.

### BEST MODE FOR CARRYING OUT THE INVENTION

In the following, a reinforcing device and a reinforcing method for a core spray system piping according to embodiments of the present invention will be described with reference to the accompanying drawings. Further, it is to be noted that terms, such as upper, lower, left and right, and the like showing direction or attitude used in the following description are ones in the state illustrated in the relevant drawing or in the state of an actually installed state of the reinforcing device.

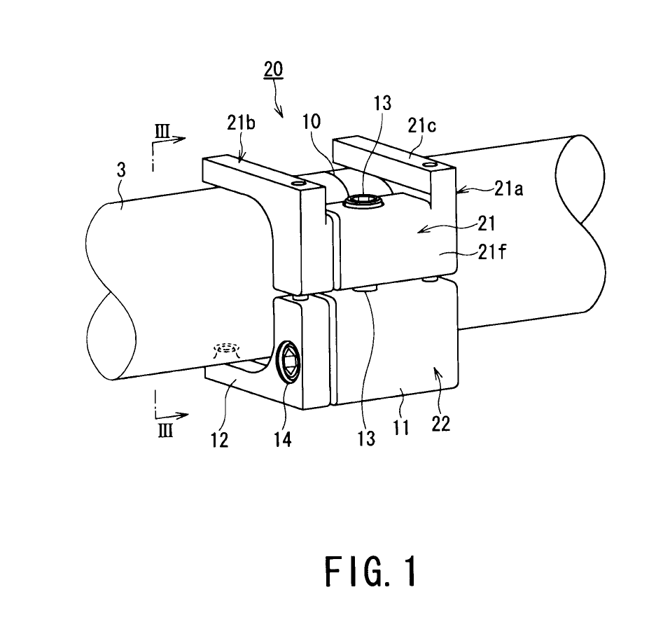

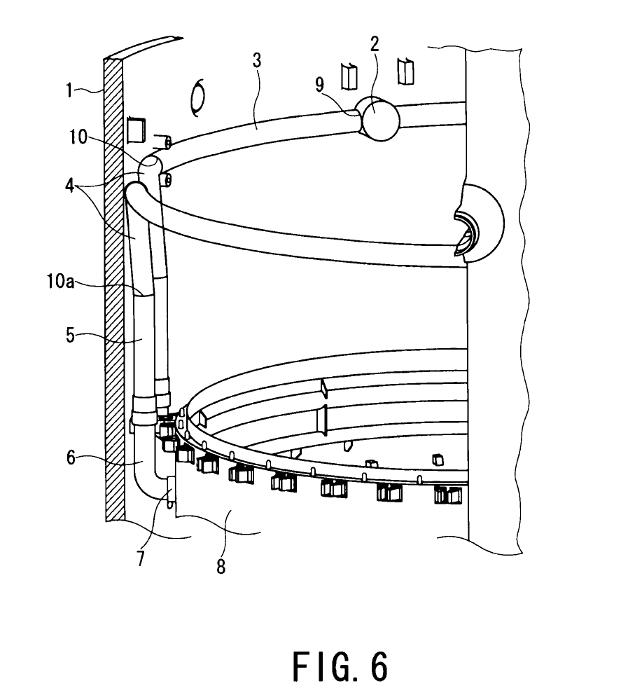

FIG. 1 is a perspective view of the whole of a reinforcing device 20 according to an embodiment of the present invention attached to the core spray system piping 3 shown in FIG. 6 described earlier, and it is to be noted that the arrangement described below is only an illustrative example, and the position of the reinforcing device 20 attached to the core spray system piping 3 is not limited to any particular position.

As shown in FIG. 1, the core spray system piping 3 extends horizontally, for example, and the reinforcing device 20 according to this embodiment includes an upper clamp 21 and a lower clamp 22 that hold the core spray system piping 3 from upper and lower sides thereof, respectively.

The upper clamp 21 is a block having an inverted L-shape in a side view and is provided with a right upper clamp portion 21a and a left upper clamp portion 21b. The right upper clamp portion 21a includes a body portion 21f having a vertical plate shape and an arm portion 21c horizontally protruding from the body portion 21f. The left upper clamp portion 21b has substantially the same shape as the right upper clamp portion 21a and is coupled to a side portion of the right upper clamp portion 21a to be horizontally opposed to the right upper clamp portion 21a.

The lower clamp 22 is a block having a substantially L-shape in a side view and is provided with a right lower clamp portion 11 and a left lower clamp portion 12. The right lower clamp portion 11 includes a body portion having a vertical plate shape and an arm portion horizontally protruding from one side of the body portion. The left lower clamp portion 12 has substantially the same shape as the side portion of the right lower clamp portion 11 and is coupled to the other side of the right lower clamp portion 11 to be horizontally opposed to the right lower clamp portion 11.

The upper clamp 21 and the lower clamp 22 are coupled to each other by a vertical coupling bolt 13 at a substantially central portion thereof in a plan view. The right lower clamp portion 11 and the left lower clamp portion 12 are coupled to each other by means of a horizontal coupling bolt 14.

The reinforcing device 20 thus configured is disposed on one side of the core spray system piping 3 in contact with the side surface of the core spray system piping 3 and holds the core spray system piping 3 from the upper and lower sides thereof with the left clamp portions and the right clamp portions being disposed on the opposite sides of a welded seam 10.

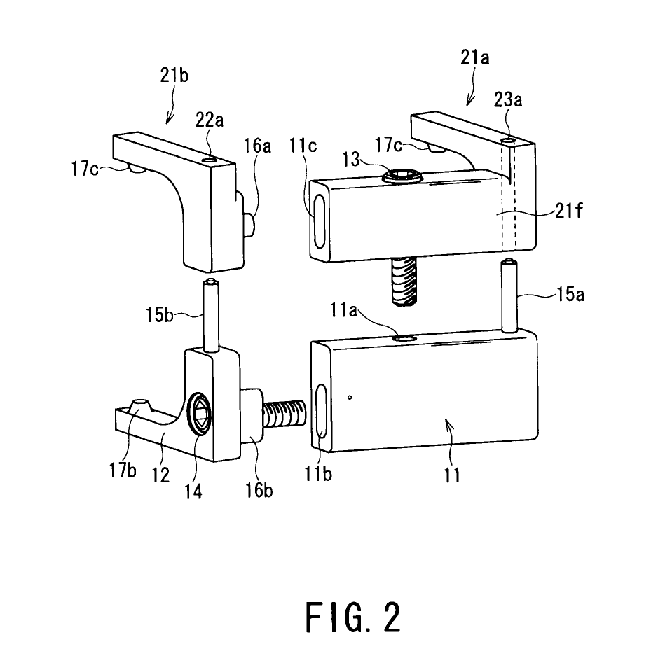

FIG. 2 is an exploded perspective view of components of the reinforcing device 20 described above. As shown in FIG. 2, a bar-shaped vertical guide 15a protruding vertically upward is provided on a right end of the right lower clamp portion 11. The vertical guide 15a can be inserted in a vertical guide hole 23a formed in the right upper clamp portion 21a.

A downward protrusion 17c is provided on a lower surface of a tip end of the right upper clamp portion 21a. The protrusion 17c abuts against an upper surface of the core spray system piping 3. A threaded hole 11a is formed in the right lower clamp portion 11 at a center of an upper surface thereof, and a lower end of the vertical coupling bolt 13 inserted in the body portion 21f is screwed into the threaded hole 11a.

In addition, an elongated guide insertion hole 11b is formed in the left side of the right lower clamp portion 11. An elongated horizontal guide 16b, which is screwed in the left lower clamp portion 12, is fitted into the guide insertion hole 11b, and a tip end of the horizontal coupling bolt 14 protruding from a tip end of the horizontal guide 16b is screwed into a threaded hole, not shown, formed inside the guide insertion hole 11b. An upward protrusion 17b is provided on the left lower clamp portion 12 and the right lower clamp portion 11, and the downward protrusion 17c described above is provided not only the right upper clamp portion 21a but also on the left upper clamp portion 21b. Each of these protrusions abuts against the upper or lower surface of the core spray system piping 3.

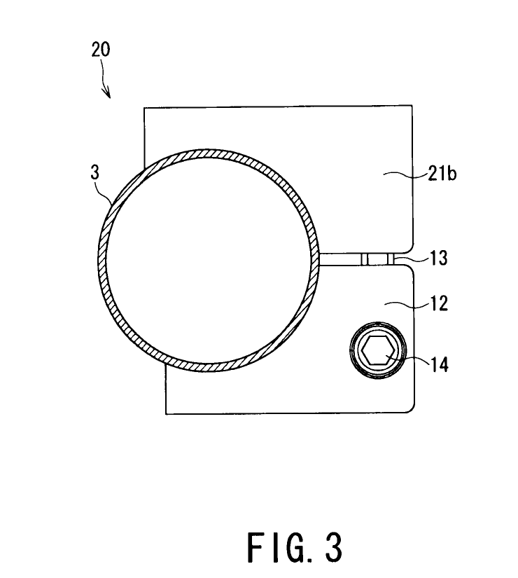

FIG. 3 is a cross-sectional view taken along the line III-III in FIG. 1. As shown in FIG. 3, the reinforcing device 20 holds the core spray system piping 3 from upper and lower sides thereof between the right upper clamp portion 21a and the right lower clamp portion 1 and between the left upper clamp portion 21b and the left lower clamp portion 12 by the action of the vertical coupling bolt 13 and the horizontal coupling bolt 14 to thereby be fixed to the core spray system piping 3 at a plurality of points in an axial direction of the core spray system piping 3. Since the reinforcing device 20 is attached to the core spray system piping 3 in this way, occurrence of twisting or bending of the piping 3 between the clamp portions is prevented.

As described above, the left and right, upper and lower clamp portions 21b, 21a, 12 and 1 each have a contact portion having a shape conforming to the outer shape of the core spray system piping 3 and are arranged to be located on the opposite sides of the weld line in the core spray system piping 3. These clamp portions are fixed by a frictional force produced between the clamp portions and the core spray system piping 3 by fastening the vertical coupling bolt 13.

In addition, when the horizontal coupling bolt 14 is fastened, the left and right, upper and lower clamp portions 21b, 21a, 12 and 1 apply a compressive force to the welded seam to keep the seam even if the welded portion is damaged.

In addition, recesses are formed in the core spray system piping 3, and the protrusions 17b and 17c on the clamp portions are engaged with the recesses to thereby restrict the horizontal and vertical movement of the clamps in addition to the frictional force caused by fastening the clamps.

A plurality of protrusions 17b, 17c may be formed on each clamp portion, and the recesses formed in the piping may be through holes or grooves that do not penetrate the wall of the piping. With any of these arrangements, the same effects and advantages will be achieved.

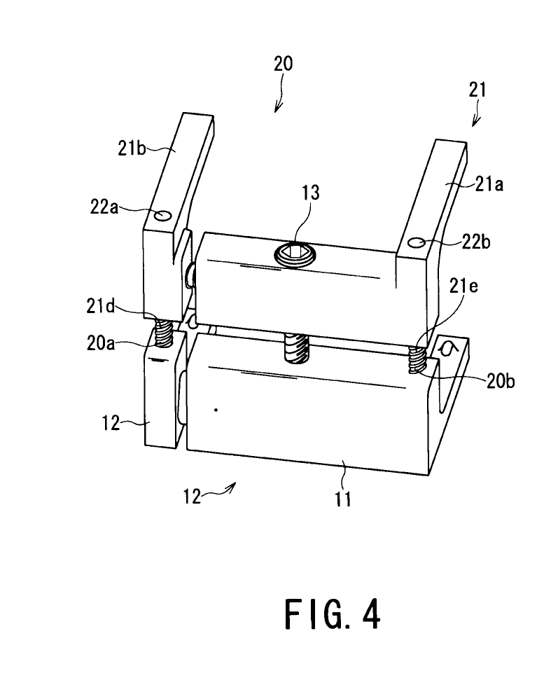

FIG. 4 shows a configuration of the clamps of the reinforcing device 20, in which the upper clamp 21 and the lower clamp 12 fastening the core spray system piping 3 have fastening surfaces having the same curvature as that of the piping 3, thus increasing the fastening frictional force.

Springs, such as compression springs 20a and 20b, are fitted around guide pins 21d and 21e acting to guide the fastening direction. The springs are fixed to the guide pins 21d and 21e at one end thereof and fixed to guide grooves 22a and 22b at the other end thereof. Therefore, the springs always apply a force in the fastening direction to the upper and lower clamps.

This arrangement has an effect of reducing a vibration transmitted from the piping to the clamps to prevent loosening of the vertical coupling bolt 13 because of the vibration of the piping and provides a backup structure to keep the clamps coupled in case of breakage of the bolt.

As an alternative to the springs 20a and 20b, a plurality of magnets of opposite polarities may be alternately disposed on the guide pins 21d and 21e and in the guide grooves 22a and 22b.

The clamp device described above may have any configuration that can hold the core spray system pining between the clamps. For example, the upper clamp and the lower clamp may be replaced with an integrated clamp.

In addition, for example, the device used to couple and fasten the clamps is not limited to the bolt described above and any device that provides mechanical fastening may be usable.

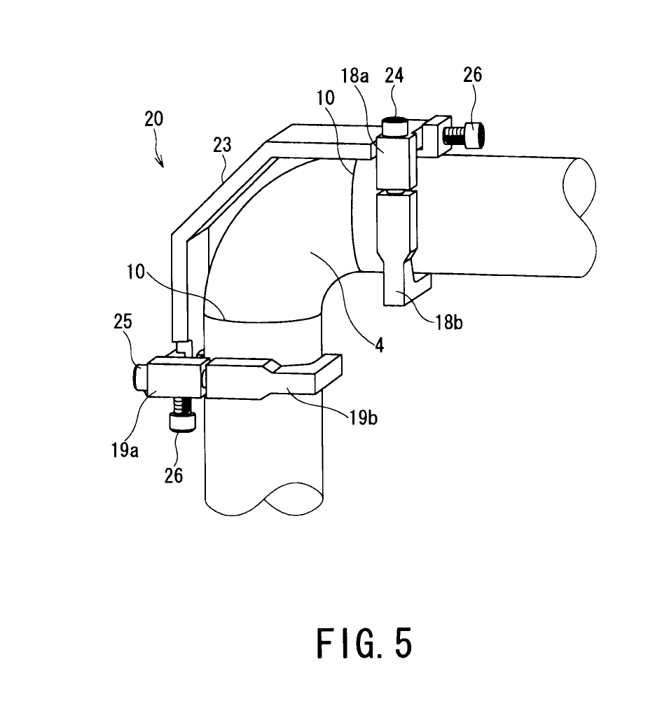

FIG. 5 is a perspective view showing another embodiment of the present invention.

According to the embodiment shown in FIG. 5, an elbow clamp for an elbow portion 4 is provided with upper elbow clamp portions 18a and 18b each having a contact portion conforming to the outer shape of a horizontal portion of the elbow portion 4, lower elbow clamp portions 19a and 19b each having a contact portion conforming to the outer shape of a vertical portion of the elbow portion 4, and a clamp body 23 that couples the upper elbow clamp portions and the lower elbow clamp portions to each other.

The elbow clamp further includes an upper fastening bolt 24 that fastens the upper elbow clamp portions 18a and 18b to the horizontal portion of the core spray system piping 3, a lower fastening volt 25 that fastens the lower elbow clamp portions 19a and 19b to the core spray system piping 3, and coupling bolts 26 that fasten the clamp portions to the clamp body 23 to apply a compression force to the welded seams at the elbow portion 4.

According to the embodiment shown in FIG. 5, because of the clamp body 23 shaped to conform to the shape of the elbow portion 4 and the coupling bolts 26 for clamp fastening, the same effects and advantages as those attained by the embodiment shown in FIGS. 1 to 4 can be achieved by the coupling pipes, at the elbow portion 4, of the core spray system piping 3.

The shape of the clamp body 23 according to the embodiment shown in FIG. 5 is only an illustrative example, and the same effects and advantages can be achieved even if the clamp body 23 is configured to be pressed against the elbow portion 4.

As described above, the reinforcing device 20 according to the present embodiment is disposed on the outer side of the welded portion of the core spray system piping 3 and holds the core spray system piping 3 at axially symmetrical portions on the outer surface of the core spray system piping 3 located on the opposite sides of the weld line 10 of the welded portion. The reinforcing device 20 further includes bolts 13 and 14 that serve as a mechanical fastening mechanism disposed on the clamp 21 or the like and applies a compressive force to the welded part from outside of the core spray system piping.

The clamp 21 and the bolts 13 and 14 serving as the mechanical fastening mechanism have a guide member that restrains a twisting force and a bending force on the outer surface of the core spray system piping.

The clamp 21 has a fastening surface having the same curvature as the curvature of the outer surface of the core spray system piping 3, 4 and includes a plurality of components that hold the outer surfaces of the core spray system piping 3, 4 from the opposite directions. These components are supported by a vertical guide 15a serving as a guide pin and a guide groove, to which the guide pin is inserted, which are disposed so as to oppose to each other, for example.

Guide pins and guide grooves are provided with magnets of opposite polarities, not shown, in an alternate manner. A protrusion is formed on the clamp 21, and the protrusion is engaged with a hole formed in the piping to restrict the movement of the clamp.

Alternatively, a protrusion is formed on the clamp 21 so as to be engaged with a groove formed in the piping to restrict the movement of the clamp. The clamp 21 is configured to allow approximately half or more of the length of the weld line of the welded portion to be visually checked from the upper side of the reactor pressure vessel. Furthermore, the portion of the core spray system piping to be reinforced is formed as an elbow pipe.

According to the present invention, the reinforcing device for core spray system piping described above is used to prevent occurrence of a crack at the weld line in the core spray system piping, prevent widening of a crack in the core spray system piping and maintain the functionality of the core spray system piping even if the core spray system piping is broken at the weld line.

As described above, the clamp device according to the present embodiment can hold and fix the core spray system piping 3 to prevent occurrence of a crack at the welded portion of the core spray system piping and widening of a crack occurring in the core spray system piping. In addition, even if the core spray system piping is broken at the weld line, the clamp device according to the present embodiment can prevent the pipes from being separated or laterally displaced at the welded seam.

1. A device for reinforcing a core spray system piping that reinforces a welded portion of the core spray system piping of a boiling water reactor, comprising:
a clamp disposed on an outer side of the welded portion of the core spray system piping and configured to hold the core spray system piping at axially symmetrical points on an outer surface of the core spray system piping located on opposite sides of a weld line of the welded portion; and
a mechanical fastening mechanism provided on the clamp and configured to apply a compressive force to the welded portion from an outside of the core spray system piping.

2. The reinforcing device for the core spray piping according to claim 1, wherein the clamp and the mechanical fastening mechanism have a guide mechanism that restrains a twisting force and a bending force on the outer surface of the core spray system piping.

3. The reinforcing device for the core spray piping according to claim 1, wherein the clamp has a fastening surface having a same curvature as a curvature of the outer surface of the core spray system piping.

4. The reinforcing device for the core spray system piping according to claim 1, wherein the clamp comprises a plurality of components that hold the outer surface of the core spray system piping from opposite directions, and the components are supported by a guide pin and a guide groove, to which the guide pin is inserted, which are disposed so as to face each other.

5. The reinforcing device for the core spray system piping according to claim 1, wherein the guide pins and the guide grooves are provided with magnets of opposite polarities in an alternate manner.

6. The reinforcing device for the core spray system piping according to claim 1, wherein a protrusion is formed on the clamp, and a hole is formed in the piping so as to be engaged with the protrusion to thereby restrict movement of the clamp.

7. The reinforcing device for the core spray system piping according to claim 1, wherein a protrusion is formed on the clamp, and a groove is formed in the piping so as to be engaged with the protrusion to thereby restrict movement of the clamp.

8. The reinforcing device for the core spray system piping according to claim 1, wherein the clamp is configured to allow approximately half or more of the length of the weld line of the welded portion to be visually checked from an upper side of a reactor pressure vessel.

9. The reinforcing device for the core spray system piping according to claim 1, wherein a portion of the core spray system piping to be reinforced is an elbow pipe.

10. A method of reinforcing a core spray system piping using a device for reinforcing the core spray system piping for reinforcing a welded portion of the core spray system piping of a boiling water reactor, the reinforcing device comprising a clamp that holds the core spray system piping at axially symmetrical points on an outer surface of the core spray system piping and a mechanical fastening mechanism that is provided on the clamp and applies a compressive force, the reinforcing method comprising:
Holding, by the clamp, the core spray system piping at axially symmetrical points on the outer surface of the core spray system piping; and
applying a compressive force, by the mechanical fastening mechanism, to the welded portion from an outside of the core spray system piping to prevent occurrence of a crack at a weld line in the core spray system piping to thereby prevent widening of a crack in the core spray system piping and to maintain a function of the core spray system piping in a case where the core spray system piping is broken at the weld line.
